(19) United States
(12) Patent Application Publication
(10) Pub. No.: US 2020/0190309 A1
(43) Pub. Date: Jun. 18, 2020

(54) Polylactide Based Compositions

(71) Applicant: TOTAL RESEARCH & TECHNOLOGY FELUY, Seneffe (BE)

(72) Inventors: Thierry Coupin, Carnieres (BE); Marion Helou, Quimper (FR); Martine Slawinski, Nevelles (BE); Steven Henning, Downington, PA (US)

(21) Appl. No.: 16/641,294

(22) PCT Filed: Aug. 9, 2018
(86) PCT No.: PCT/EP2018/071661

§ 371 Date: Feb. 24, 2020

(30) Foreign Application Priority Data
Aug. 24, 2017 (EP) 17187791.3

(51) Int. Cl. C08L 53/00; C08L 67/04; C08F 299/02

(52) U.S. Cl. CPC C08L 53/005; C08L 2205/08; C08F 299/02; C08L 67/04

(57) ABSTRACT

The present invention relates to a block copolymer, being the reaction product of:
at least one functionalized polyfarnesene comprising a polymeric chain derived from farnesene and having at least one functional terminal end selected from the group comprising hydroxyl, amino, epoxy, isocyanato, and carboxylic acid; and
at least one lactide;
   forming at least one polyfarnesene block and at least one polylactide block.

The present invention also relates to a process for preparing said block copolymer, a polymer composition comprising said block copolymer, an article comprising said block copolymer, the use of said block copolymers as impact modifier and the use of said block copolymer as compatibilizer.

### FIELD OF THE INVENTION

The invention pertains to a composition comprising a polylactide-based polymer, and the use thereof.

### BACKGROUND OF THE INVENTION

Polylactide also referred as polylactic acid (PLA) is a synthetic aliphatic polyester derived from renewal resources, such a corn, sugar beet and cassava, which can ultimately be degraded under composting conditions.

Although attempts have been made to utilize PLA for various end-use applications, PLA is known to be brittle and exhibit low toughness, which can result in low impact strength products or articles. Impact resistance of PLA can be modified by using existing polymeric impact modifiers; however, currently available polymeric impact modifiers always decrease transparency of PLA material. A liquid plasticizer can be used at high content (>15%) to improve impact resistance of PLA, however during the life time of the PLA blend, there is migration of the plasticizer.

Impact modifiers such as rubber, poly(ethylene glycol) (PEG), and acrylonitrile-butadiene-styrene copolymer (ABS) have been tested. Nevertheless, the immiscibility between these impact modifying additives and the PLA matrix is a major drawback.

Commercially available BioStrength® 150 a methyl methacrylate-butadiene-styrene co-polymer (MBS) is one of the best currently available impact modifiers for PLA; however haze of the resulting PLA material increases from 5, for pure PLA to 95 when 15% w/w of BioStrength® 150 is added. Another commercial product, BioStrength® 280, an acrylic core shell impact modifier, is a less efficient impact modifier, although the resulting PLA material is said to remain transparent. Nevertheless, the present inventors observed that addition of 15% w/w of BioStrength® 280 produces a material with a haze of 44.

Plasticizers are additives that increase the fluidity of a material. Commonly used plasticizers, are tributyl citrate (TBC) and acetyl tributyl citrate (ATBC). However, when 15% TBC or ATBC were mixed with PLA, the present inventors observed a plasticizer migration after storage for a few days at room temperature in summer time (25-30° C.).

Other commonly used polymer modifiers are styrene block copolymers, such as poly(styrene-butadiene-styrene), or SBS. Further studies performed by the present inventors, showed that a blend of PLA with SBS exhibited a total incompatibility even at a concentration as low as 10% w/w of SBS.

There is therefore a need to improve the compositions of the prior art.

### SUMMARY OF THE INVENTION

The inventors have surprisingly found that polylactide-polyfarnesene (PLA-PF) block copolymer, increases significantly the impact properties of PLA based composition in comparison to polylactide based composition alone, or in comparison with standard impact modifiers.

The inventors have surprisingly found that compositions comprising at least one PLA based polymer and polylactide-polyfarnesene (PLA-PF) block copolymer, have a better impact performance than the same compositions comprising standard impact modifiers. The compositions can have also improved transparency, while keeping other properties such as processing.

A first aspect of the present invention provides a block copolymer, being the reaction product of:
at least one functionalized polyfarnesene comprising a polymeric chain derived from farnesene and having at least one functional terminal end selected from the group comprising hydroxyl, amino, epoxy, isocyanato, and carboxylic acid; and
at least one lactide;
   forming at least one polyfarnesene block and at least one polylactide block.

The present inventors have surprisingly found that it is possible to produce composition having improved tensile modulus and impact resistance.

A second aspect of the present invention provides a process for manufacturing a block copolymer comprising the steps of:
contacting at least one functionalized polyfarnesene comprising a polymeric chain derived from farnesene and having at least one functional terminal end selected from the group comprising hydroxyl, amino, epoxy, isocyanato, and carboxylic acid;
with at least one lactide; and polymerizing said lactide in the presence of said at least one functionalized polyfarnesene;
thereby forming said block copolymer comprising at least one polyfarnesene block and at least one polylactide block.

A third aspect of the invention provides a polymer composition, comprising:
at least one polylactide; and,
at least one block copolymer according to the first aspect of the invention, or obtained according to a process according to the second aspect of the invention.

A fourth aspect of the invention encompasses a process for preparing a polymer composition according to the third aspect of the invention, comprising the step of contacting at least one polylactide with at least one block copolymer according to the first aspect of the invention.

A fifth aspect of the invention encompasses an article comprising at least one block copolymer according to the first aspect of the invention, or obtained according to a process according to the second aspect of the invention, or a composition according to the third aspect of the invention, or prepared using a process according to the fourth aspect of the invention.

A sixth aspect of the invention encompasses the use of a polyfarnesene and polylactide block copolymer as a compatibilizer for polymers.

A seventh aspect of the invention encompasses the use of a polyfarnesene and polylactide block copolymer as an impact modifier for polymers.

By better performance is meant that the impact modifier performs either better in terms of the impact strength used at the same quantity as the nowadays-available standard impact modifiers or the same impact strength is obtained by incorporating less quantity of the impact modifier in comparison to the nowadays-available standard impact modifiers in a thermoplastic resin, while keeping other characteristics.

The above and other characteristics, features and advantages of the present invention will become apparent from the following detailed description, taken in conjunction with the accompanying drawings, which illustrate, by way of example, the principles of the invention. The reference figures quoted below refer to the attached drawings.

### DETAILED DESCRIPTION OF THE INVENTION

When describing the invention, the terms used are to be construed in accordance with the following definitions, unless a context dictates otherwise.

As used herein, the singular forms “a”, “an”, and “the” include both singular and plural referents unless the context clearly dictates otherwise. By way of example, “a resin” means one resin or more than one resin.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

Preferred statements (features) and embodiments of the compositions, polymers, processes, articles, and uses of this invention are set herein below. Each statement and embodiment of the invention so defined may be combined with any other statement and/or embodiment, unless clearly indicated to the contrary. In particular, any feature indicated as being preferred or advantageous may be combined with any other features or statements indicated as being preferred or advantageous. Hereto, the present invention is in particular captured by any one or any combination of one or more of the below numbered aspects and embodiments 1 to 47, with any other statement and/or embodiment.
1. Block copolymer, being the reaction product of:
   at least one functionalized polyfarnesene comprising a polymeric chain derived from farnesene and having at least one functional terminal end selected from the group comprising hydroxyl, amino, epoxy, isocyanato and carboxylic acid; and
   at least one lactide;
   forming at least one polyfarnesene block and at least one polylactide block.
2. Block copolymer according to statement 1, being the reaction product of:
   at least one polymeric chain derived from farnesene and having at least one functional terminal end selected from the group comprising hydroxyl, amino, epoxy, isocyanato and carboxylic acid; and
   at least one lactide.
3. Block copolymer according to any one of statements 1-2, wherein said block copolymer is selected from the group comprising PLA-PF diblock copolymer, PLA-PF-PLA triblock copolymer, PLA-PF multiblock copolymer, PLA-PF star copolymers, PLA-PF gradient containing block copolymers; and mixtures thereof; preferably said block copolymer is a PLA-PF diblock copolymer or a PLA-PF-PLA triblock copolymer.
4. Block copolymer according to any one of statements 1-3, wherein said block copolymer is a di-block or a triblock copolymer.
5. Block copolymer according to any one of statements 1-4, wherein the number average molecular weight Mn of the at least one polyfarnesene block is at least 1.5 kDa, preferably at least 2.0 kDa, preferably at least 3.0 kDa, for example at least 4.0 kDa, for example at least 5.0 kDa, for example at least 6.0 kDa, for example at least 7.0 kDa, for example at least 8.0 kDa, for example at least 9.0 kDa, for example at least 10 kDa, for example at least 12 kDa, for example at least 15 kDa, for example at least 17 kDa, for example at least 18 kDa, for example at least 20 kDa, for example at least 30 kDa, for example at least 40 kDa, for example at least 50 kDa, for example at least 60 kDa, for example at least 70 kDa, for example at least 80 kDa, for example at least 90 kDa, for example at least 100 kDa, for example at least 110 kDa, for example at least 120 kDa, for example at least 130 kDa, for example at least 150 kDa, for example at least 200 kDa.
6. Block copolymer according to any one of statements 1-5, wherein the number average molecular weight Mn of the at least polyfarnesene block is at most 300 kDa, at most 250 kDa, preferably at most 240 kDa, preferably at most 230 kDa, preferably at most 220 kDa, for example at most 210 kDa, for example at most 200 kDa, for example at most 150 kDa, for example at most 140 kDa.
7. Block copolymer according to any one of statements 1-6, wherein the number average molecular weight Mn of the at least one polyfarnesene block is preferably from 1.5 to 300 kDa, preferably from 2 to 250 kDa, preferably from 5 to 240 kDa, more preferably from 10 to 210 kDa, preferably from 15 to 200 kDa, preferably from 20 to 150 kDa.
8. Block copolymer according to any one of statements 1-7, wherein the number average molecular weight Mn of the at least one polylactide block is at least 0.1 kDa, preferably at least 0.2 kDa, preferably at least 0.5 kDa, for example at least 0.7 kDa, for example at least 0.8 kDa, for example at least 0.9 kDa, for example at least 1.0 kDa, for example at least 2.0 kDa, for example at least 3.0 kDa, for example at least 5.0 kDa, for example at least 10 kDa, for example at least 15 kDa, for example at least 20 kDa, for example at least 30 kDa, for example at least 40 kDa, for example at least 50 kDa, for example at least 60 kDa, for example at least 70 kDa, for example at least 80 kDa, for example at least 90 kDa, for example at least 100 kDa, for example at least 150 kDa.
9. Block copolymer according to any one of statements 1-8, wherein the number average molecular weight Mn of the at least one polylactide block is at most 400 kDa, preferably at most 350 kDa, preferably at most 300 kDa, for example at most 250 kDa, for example at most 200 kDa, for example at most 190 kDa, for example at most 180 kDa, for example at most 170 kDa, for example at most 160 kDa, for example at most 150 kDa, for example at most 140 kDa, for example at most 130 kDa, for example at most 120 kDa, for example at most 110 kDa, for example at most 111 kDa.
10. Block copolymer according to any one of statements 1-9, wherein the number average molecular weight Mn of the at least one polylactide block is preferably from 0.2 to 400 kDa, preferably from 1 to 250 kDa, preferably from 2 to 250 kDa, preferably from 3 to 250 kDa, preferably from 10 to 200 kDa, more preferably from 20 to 170 kDa, preferably from 30 to 140 kDa, preferably from 60 to 111 kDa.
11. Block copolymer according to any one of statements 1-10, comprising one polyfarnesene block.
12. Block copolymer according to any one of statements 1-11, comprising one or two polylactide blocks.
13. Block copolymer according to any one of statements 1-12, comprising two polylactide blocks.
14. Block copolymer according to any one of statements 1-13, wherein the number average molecular weight is the same within 1000 Da for two or more polylactide (PLA) blocks.
15. Block copolymer according to any one of statements 1-14, wherein the at least one polylactide (PLA) block is selected from the group comprising poly-L-lactide, poly-D-lactide, poly-DL-lactide, poly-meso-lactide, and mixture thereof.
16. Block copolymer according to any one of statements 1-15, wherein the functionalized polyfarnesene comprises a polymeric chain derived from farnesene and having at least one functional terminal end selected from the group comprising hydroxyl, amino, and epoxy.
17. Block copolymer according to any one of statements 1-16, wherein the functionalized polyfarnesene comprises a polymeric chain derived from farnesene and having at least one functional terminal end selected from the group comprising hydroxyl and amino.
18. Block copolymer according to any one of statements 1-17, wherein the functionalized polyfarnesene comprises a polymeric chain derived from farnesene and having at least one hydroxyl terminal end.
19. Block copolymer according to any one of statements 1-18, wherein the number average molecular weight Mn of said block copolymer is at least 2 kDa, preferably at least 5 kDa, preferably at least 10 kDa, preferably at least 15 kDa, for example at least 20 kDa, for example at least 25 kDa, for example at least 30 kDa, for example at least 35 kDa, for example at least 40 kDa, for example at least 45 kDa, for example at least 50 kDa, for example at least 55 kDa.
20. Block copolymer according to any one of statements 1-19, wherein the number average molecular weight Mn of said block copolymer is at most 500 kDa, preferably at most 400 kDa, preferably at most 350 kDa, preferably at most 300 kDa, for example at most 250 kDa, for example at most 200 kDa, for example at most 150 kDa, for example at most 140 kDa, for example at most 130 kDa, for example at most 120 kDa, for example at most 110 kDa.
21. Block copolymer according to any one of statements 1-20, wherein the number average molecular weight Mn of said block copolymer is from 2 kDa to 500 kDa, preferably from 10 kDa to 400 kDa, preferably from 25 kDa to 250 kDa, preferably from 40 kDa to 160 kDa, preferably 55 kDa to 110 kDa.
22. Block copolymer according to any one of statements 1-21, wherein the ratio of the number average molecular weight of the at least one polyfarnesene block over the number average molecular weight of the at least one polylactide block is from 1/0.1 to 1/4.0, preferably from 1/0.4 to 1/3.5, preferably from 1/0.7 to 1/2.3, preferably from 1/0.9 to 1/2.0, preferably from 1/1.0 to 1/1.5.
23. Block copolymer according to any one of statements 1-22, wherein the molecular weight distribution D (Mw/Mn) of the block copolymer is from 1.0 to 2.5, preferably from 1.2 to 2.1, preferably from 1.4 to 1.9, preferably from 1.7 to 1.8.
24. Process for manufacturing a block copolymer comprising the steps of:
   contacting at least one functionalized polyfarnesene comprising a polymeric chain derived from farnesene and having at least one functional terminal end selected from the group comprising hydroxyl, amino, epoxy, isocyanato, and carboxylic acid;
   with at least one lactide; and polymerizing said lactide in the presence of said at least one functionalized polyfarnesene;
   thereby forming said block copolymer comprising at least one polyfarnesene block and at least one polylactide block.
25. Process according to statement 24, for the manufacture of a block copolymer according to any one of statements 1-23.
26. Process according to any one of statements 24-25, wherein the polymerization occurs via ring opening polymerization.
27. Process according to any one of statements 24-26, wherein the polymerization occurs in the presence of a catalyst.
28. Process according to any one of statements 24-27, wherein the polymerization occurs in the presence of a catalyst having general formula M(Y¹, Y², . . . Y^{p})_{q}, wherein M is a metal selected from the group comprising the elements of columns 3 to 12 of the periodic table of the elements, as well as the elements Al, Ga, In, TI, Ge, Sn, Pb, Sb, Ca, Mg and Bi; whereas Y¹, Y², . . . Y^{p} are each substituents selected from the group comprising alkyl with 1 to 20 carbon atoms, aryl having from 6 to 30 carbon atoms, alkoxy having from 1 to 20 carbon atoms, aryloxy having from 6 to 30 carbon atoms, and other oxide, carboxylate, and halide groups as well as elements of group 15 and/or 16 of the periodic table; p and q are integers of from 1 to 6. As examples of suitable catalysts, we may notably mention the catalysts of Sn, Ti, Zr, Zn, and Bi; preferably an alkoxide or a carboxylate and more preferably Sn(Oct)₂, Ti(OiPr)₄, Ti(2-ethylhexanoate)₄, Ti(2-ethylhexyloxide)₄, Zr(OiPr)₄, Bi(neodecanoate)₃, (2,4-di-tert-butyl-6-(((2-(dimethylamino)ethyl)(methyl)amino)methyl)phenoxy)(ethoxy)zinc, or Zn(lactate)₂.
29. Process according to any one of statements 24-28, wherein the block copolymer is a block copolymer according to any one of statements 1-23.
30. Polymer composition, comprising:
   at least one polylactide; and,
   at least one block copolymer according to any one of statements 1-23, or prepared according to the process of any one of statement 24-29.
31. Polymer composition according to statement 30, wherein said polylactide is selected from the group comprising poly-L-lactide, poly-D-lactide, poly-DL-lactide, poly-meso-lactide, and mixture thereof.
32. Polymer composition according to any one of statements 30-31, wherein said at least one block copolymer is present in said polymer composition in an amount of at least 1.0% by weight, preferably at least 5.0% by weight, preferably at least 10% by weight, for example at least 15% by weight, for example at least 20% by weight, for example at least 25% by weight, for example at least 26% by weight, for example at least 27% by weight, for example at least 28% by weight, for example at least 30% by weight, based on the total weight of the polymer composition.
33. Polymer composition according to any one of statements 30-32, wherein said at least one block copolymer is present in said polymer composition in an amount of at most 70% by weight, preferably at most 65% by weight, preferably at most 60% by weight, for example at most 55% by weight, for example at most 50% by weight based on the total weight of the polymer composition.
34. Polymer composition according to any one of statements 30-33, wherein said at least one block copolymer is present in said polymer composition in an amount of from 1.0 to 70% by weight, preferably from 5.0 to 65% by weight, preferably from 10 to 60% by weight, preferably from 15 to 55% by weight, preferably from 20 to 50% by weight, based on the total weight of the polymer composition.
35. Polymer composition according to any one of statements 30-34, further comprising at least one compatibilizer.
36. Polymer composition according to any one of statements 30-35, further comprising at least one compatibilizer being a co- or ter-polymer comprising (a) 50 to 99.9% by weight of ethylene or styrene monomer, (b) 0.1 to 50% by weight of an unsaturated anhydride-, epoxide- or carboxylic acid-containing monomer, and (c) 0 to 50% by weight of a (meth)acrylic ester monomer.
37. Process for preparing a polymer composition according to any one of statements 30-36, comprising the step of contacting at least one polylactide with at least one block polymer according to any one of statements 1-23, or prepared according to any one of statements 24-29.
38. Process according to statement 37, wherein said contacting step comprises melt blending the at least one polylactide with the at least one block copolymer.
39. Process according to any one of statement 37-38, wherein said contacting step comprises melt blending the at least one polylactide with the at least one block copolymer at a temperature ranging from 160° C. to 230° C., preferably at a temperature ranging from 160° C. to 200° C.
40. Process according to any one of statements 37-39, further comprising processing the polymer composition using one or more polymer processing techniques selected from the group comprising film, sheet, pipe and fiber extrusion or coextrusion; blow molding; injection molding; rotomolding; foaming; and thermoforming.
41. An article comprising a block copolymer according to any one of statements 1-23 or prepared according to any one of statements 24-29, or comprising a polymer composition according to any one of statements 30-36, or formed using a process according to any one of statements 37-40.
42. Use of a polyfarnesene and polylactide block copolymer as a compatibilizer for polymers.
43. Use according to statement 42, wherein said polymer is polylactide.
44. Use according to any of one of statements 42-43, wherein the polyfarnesene and polylactide block copolymer is a block copolymer according to any one of statements 1-23 or prepared according to any one of statements 24-29.
45. Use of a polyfarnesene and polylactide block copolymer as an impact modifier for polymers.
46. Use according to statement 45, wherein said polymer is polylactide.
47. Use according to any of one of statements 45-46, wherein the polyfarnesene and polylactide block copolymer is a block copolymer according to any one of statements 1-23, or prepared according to any one of statements 24-29.

According to the first aspect of the invention, a block copolymer is provided, said block copolymer being the reaction product of:
at least one functionalized polyfarnesene comprising a polymeric chain derived from farnesene and having at least one functional terminal end selected from the group comprising hydroxyl, amino, epoxy, isocyanato, and carboxylic acid; and
at least one lactide;
   forming at least one polyfarnesene block and at least one polylactide block.

Suitable block copolymer comprises polymer comprising multiple sequences, or blocks, of the same monomer alternating in series with different monomer blocks; these blocks are covalently bound to each other. Block copolymers are normally prepared by controlled polymerization of one monomer, followed by chain extension with a different monomer. Block copolymers are classified based on the number of blocks they contain and how the blocks are arranged. For example, block copolymers with two blocks are called diblocks; those with three blocks are triblocks; and those with more than three are generically called multiblocks. Classifications by arrangement include the linear, or end-to-end, arrangement and the star arrangement, in which one polymer is the base for multiple branches.

In an embodiment, said block copolymer is selected from diblock copolymer, triblock copolymer, multiblock copolymer, star copolymers, comb copolymers, gradient containing block copolymers, and other copolymers having a blocky structure, which will be known by those skilled in the art. Preferred are diblock and triblock copolymers. An example of a gradient containing block copolymer is when the monomer or monomers used from one segment are allowed to further react as a minor component in the next sequential segment. For example, if the monomer mix used for the 1st block (A block) of an AB diblock copolymer is polymerized to only 80% conversion, then the remaining 20% of the unreacted monomer is allowed to react with the new monomers added for the B block segment, the result is an AB diblock copolymer in which the B segment contains a gradient of the A segment composition. The term “comb copolymer,” as used herein, describes a type of graft copolymer, wherein the polymeric backbone of the graft copolymer is linear, or essentially linear and is made of one polymer A, and each side chain (graft segment) of the graft copolymer is formed by a polymer B that is grafted to the polymer A backbone. Used herein, the terms “comb copolymer” and “graft copolymer” have the same meaning.

Preferably, said block copolymer is selected from the group comprising PLA-PF diblock copolymer, PLA-PF-PLA triblock copolymer, PLA-PF multiblock copolymer, PLA-PF star copolymers, PLA-PF gradient containing block copolymers; and mixtures thereof; preferably said block copolymer is a PLA-PF diblock copolymer or a PLA-PF-PLA triblock copolymer.

Preferably, said block copolymer is a di-block or a triblock copolymer.

In some embodiments, the block copolymer may comprise one polyfarnesene block.

In some embodiments, the block copolymer may comprise one or two polylactide blocks and in some embodiments the block copolymer comprises just two polylactide blocks.

In some embodiments, the melt temperature of the block copolymer is from 130 to 180° C., preferably from 150 to 177° C., preferably from 170 to 175° C., determined according to ISO 11357 with a gradient from 20 to 220° C. at 20° C./min.

In some embodiments, the crystallization temperature of the block copolymer is from 95° C. to 130° C., preferably from 100 to 126° C., preferably from 107 to 117° C., determined according to ISO 11357 with a gradient from 20 to 220° C. at 20° C./min.

In some embodiments, the block copolymer has a tensile modulus from 5.0 to 3300.0 MPa, preferably from 350.0 to 2500.0 MPa, preferably from 900.0 to 2300.0 MPa, preferably from 1500.0 to 2200.0 MPa, determined according to ISO527-2012_1BA.

In some embodiments, the block copolymer has a tensile strength at yield from 0.5 to 75.0 MPa, preferably from 0.7 to 60.0 MPa, preferably from 1.0 to 40.0 MPa, preferably from 5.0 to 20.0 MPa determined according to ISO527-2012_1BA.

In some embodiments, the block copolymer has an elongation at yield from 0.5 to 10.0%, preferably from 0.7 to 7.0%, preferably from 1.0 to 5.0% MPa, preferably from 1.0 to 3.0% determined according to ISO527-2012_1BA.

In some embodiments, the block copolymer has a tensile strength at break from 0.1 to 60.0 MPa, preferably from 0.6 to 40.0 MPa, preferably from 0.8 to 30.0 MPa, preferably from 1.0 to 18.0 MPa determined according to ISO527-2012_1BA.

In some embodiments, the block copolymer has an elongation at break from 0.5 to 70.0%, preferably from 0.7 to 50.0%, preferably from 1.0 to 25.0% MPa, preferably from 1.0 to 13.0% determined according to ISO527-2012_1BA.

According to the invention, said block copolymer is the reaction product of:
at least one functionalized polyfarnesene comprising a polymeric chain derived from farnesene wherein said polymeric chain has (comprises) at least one functional terminal end selected from the group comprising hydroxyl, amino, epoxy, isocyanato and carboxylic acid; and
at least one lactide;
   thereby forming at least one polyfarnesene block and at least one polylactide block.

According to the invention, the at least one functionalized polyfarnesene comprises a polymeric chain derived from farnesene, wherein said polymeric chain has (comprises) at least one functional terminal end selected from the group comprising hydroxyl, amino, epoxy, isocyanato and carboxylic acid, preferably said polymeric chain derived from farnesene comprises at least one functional terminal end selected from the group comprising hydroxyl, amino, and epoxy, more preferably said polymeric chain derived from farnesene comprises at least one functional terminal end selected from the group comprising hydroxyl, and amino, most preferably said polymeric chain derived from farnesene comprises at least one hydroxyl terminal end, for example one or two hydroxyl terminal ends. In a preferred embodiment, the at least one functionalized polyfarnesene comprises a polymeric chain derived from farnesene comprising one or two functional terminal ends selected from the group comprising hydroxyl, amino, epoxy, isocyanato and carboxylic acid, preferably said polymeric chain derived from farnesene comprises one or two functional terminal ends selected from the group comprising hydroxyl, amino, and epoxy, more preferably said polymeric chain derived from farnesene comprises a one or two functional terminal ends selected from the group comprising hydroxyl, and amino, most preferably said polymeric chain derived from farnesene comprises one or two hydroxyl terminal ends. As used herein the term “functionalized polyfarnesene comprising a polymeric chain derived from farnesene and having at least one hydroxyl terminal end” is also referred as “hydroxyl functionalized polyfarnesene”.

The polymeric chain derived from farnesene may be obtained by polymerizing a monomer feed that primarily includes farnesene.

Farnesene exists in isomer forms, such as α-farnesene ((E,E)-3,7,11-trimethyl-1,3,6,10-dodecatetraene) and β-farnesene (7,11-dimethyl-3-methylene-1,6,10-dodecatriene). As used in the specification and in the claims, “farnesene” means (E)-β-farnesene also referred as trans-β-farnesene, (CAS 18794-84-8) having the following structure:

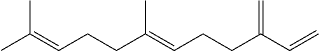

as well (E)-β-farnesene in which one or more hydrogen atoms have been replaced by another atom or group of atoms (i.e. substituted).

The farnesene monomer used to produce various embodiments of the block copolymer according to the present invention, is commercially available and may be prepared by chemical synthesis from petroleum resources, extracted from insects, such as Aphididae, or plants. Therefore, an advantage of the present invention is that the block copolymer may be derived from a monomer obtained via a renewable resource. The monomer may be prepared by culturing a microorganism using a carbon source derived from a saccharide. The polymeric chain derived from farnesene may be efficiently prepared from farnesene monomer obtained via these sources. The saccharide used may be any of monosaccharides, disaccharides, and polysaccharides, or may be a combination thereof. Examples of monosaccharides include glucose, galactose, mannose, fructose, and ribose. Examples of disaccharides include sucrose, lactose, maltose, trehalose, and cellobiose. Examples of polysaccharides include starch, glycogen, and cellulose.

The cultured microorganism that consumes the carbon source may be any microorganism capable of producing farnesene through culturing. Examples thereof include eukaryotes, bacteria, and archaebacteria. Examples of eukaryotes include yeast and plants. The microorganism may be a transformant obtained by introducing a foreign gene into a host microorganism. The foreign gene is not particularly limited, and it is preferably a foreign gene involved in the production of farnesene because it can improve the efficiency of producing farnesene.

In the case of recovering farnesene from the cultured microorganism, the microorganism may be collected by centrifugation and disrupted, and then farnesene can be extracted from the disrupted solution with a solvent. Such solvent extraction may appropriately be combined with any known purification process such as distillation.

Any methods known by those having skill in the art may be used to provide the polyfarnesene described herein. Anionic polymerization may be desirable because anionic polymerization allows greater control over the final molecular weight of the polymeric chain, i.e. narrow molecular weight distributions and predictable molecular weights. The functional terminal end of the polymeric chain may also be easily quenched, for example, by using an alkylene oxide followed by contact with a protic source providing a monol or diol.

The polymeric chain derived from farnesene described herein may be prepared by a continuous solution polymerization process wherein an initiator, monomers, and a suitable solvent are continuously added to a reactor vessel to form the desired polymeric chain. Alternatively, the polymeric chain may be prepared by a batch process in which all of the initiator, monomers, and solvent are combined in the reactor together substantially simultaneously. Alternatively, the polymeric chain may be prepared by a semi-batch process in which all of the initiator and solvent are combined in the reactor together before a monomer feed is continuously metered into the reactor.

Initiators for providing a polymeric chain with a living terminal chain end(s) include, but are not limited to, organic salts of alkali metals. Non-limiting suitable examples of such initiators are lithium and di-lithium based initiator as described in DD 231361 A1 and in WO 2016/209953 A1, hereby incorporated by reference. The polymerization reaction temperature of the mixture in the reactor vessel may be maintained at a temperature of about −80° C. to 80° C.

In some embodiments, when a mono-functionalized polyfarnesene is intended to be produced, a monovalent initiator is used. In some embodiments, when a di-functionalized polyfarnesene is intended to be produced, a divalent initiator is used.

As understood by those having skill in the art, living anionic polymerization may continue, as long as monomer is fed to the reaction. In some embodiments, the polymeric chain derived from farnesene may be obtained by polymerization of farnesene and optionally one or more comonomers. Examples of comonomers include, but are not limited to, dienes, such as butadiene, isoprene, and myrcene, or vinyl aromatics, such as styrene and alpha methyl styrene. In one embodiment of the disclosed methods and compositions, a method of manufacturing the polymeric chain may comprise polymerizing a monomer feed, wherein the monomer feed comprises farnesene monomer and optionally at least one comonomer in which the comonomer content of the monomer feed is ≤75% by weight, preferably ≤50% by weight, and preferably ≤25% by weight, based on the total weight of the monomer feed. The polymerization conditions and monomer feed may be controlled as may be desired so as to provide, for example, polymeric chain having a random, block or gradient structure.

Upon reaching a desired molecular weight, the polymeric chain may be obtained by quenching the living terminal end with a compound having the selected functionality or by providing the terminal end with a reactive group that may be subsequently functionalized. As noted previously, the functionalized polyfarnesene is provided as a polymeric chain having at least one functional terminal end selected from the group comprising hydroxyl, amino, epoxy, isocyanato and carboxylic acid.

In some embodiments, for the functionalized polyfarnesene provided in the form of a polymeric chain having one or two hydroxyl end groups, anionic polymerization may be concluded by a quenching step in which one or two living terminal ends of the polymeric chain are reacted with an alkylene oxide, such as propylene oxide, and a protic source, such as an acid, resulting in a monol, i.e. a hydroxyl group on one of the terminal ends of the polymeric chain or a diol, i.e. a hydroxyl group at both the terminal ends of the polymeric chain.

In another example, the functionalized polyfarnesene may be provided in the form of a polymeric chain having one or two carboxylic acid end group. In one method, following anionic polymerization of farnesene monomers to provide a polyfarnesene chain having one or two living terminal ends, the living terminal ends may be contacted with carbon dioxide gas to provide a terminal end with a carboxylate followed by quenching the carboxylate with an acid, such as hydrochloric, phosphoric, or sulfuric acid to convert the carboxylate into a carboxylic acid. In another method, the carboxylic acid-terminated polyfarnesene may be obtained by reacting a polyfarnesene-based monol or diol with a cyclic anhydride. Examples of cyclic anhydrides include, but are not limited to, phthalic anhydride, succinic anhydride, maleic anhydride, trimellitic anhydride, hexahydrophthalic anhydride, methyltetrahydrophthalic anhydride, itaconic anhydride, pyromellitic dianhydride, benzophenonetetracarboxylic dianhydride, and cyclopentanetetracarboxylic dianhydride.

In yet another example, the functionalized polyfarnesene may be provided in the form of a polymeric chain having one or two amino end groups. In one method, a polyfarnesene based monol or diol may be reacted with an alkane-or arenesulfonyl chloride or fluoride in the presence of a tertiary amine catalyst to form an alkane-or arenesulfonate terminated precursor. The alkane-or arenesulfonate terminated polymer may then be reacted with a primary amine or ammonia to provide the amine-terminated polyfarnesene.

Typical alkane-or arenesulfonyl compounds include, but are not limited to, methanesulfonyl chloride, methanesulfonyl fluoride, ethanesulfonyl chloride, ethanesulfonyl fluoride, p-toluenesulfonyl chloride, and p-toluenesulfonyl fluoride. Primary amines that may be reacted with the alkane-or arenesulfonate terminated polymer include, for example, ethylamine, propylamines, allylamine, n-amylamine, butylamines, cyclohexylamine, n-tetradecylamine, benzylamine, aniline, toluidines, naphthylamine and the like.

In an alternative method for producing an amine-terminated polyfarnesene, a polyfarnesene-based monol or diol may be directly reacted with ammonia. For example, as explained above, the polyfarnesene-based monol or diol may be provided by anionic polymerization of farnesene monomers in which the living terminal ends of the polymer are quenched using an epoxide followed by contact with a protic source. If the epoxide used is an alkylene oxide having the following structure:

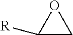

in which R is a C₁₋₂₀alkyl group, the resulting monol or diol will be a secondary alcohol. The secondary hydroxyl-groups may then be reacted directly with ammonia in the presence of hydrogen and a catalyst under pressure (e.g. >2 MPa) to provide amine-terminated polyfarnesene. A stoichiometric excess of ammonia with respect to the hydroxyl groups may be used. Examples of catalysts for the amination include, but are not limited to, copper, cobalt and/or nickel, and metal oxides. Suitable metal oxides include, but are not limited to, Cr₂O₃, Fe₂O₃ ZrO₂, Al₂O₃, and ZnO.

In yet another method, the polyfarnesene having one or two amino end groups may be obtained by adding acrylonitrile to either a primary or secondary OH end of a monol or diol through Michael addition, followed by reduction to form one or two primary amino group at the terminal ends. The polyfarnesene-based monol or diol may be dissolved in an organic solvent and mixed with a base to catalyze the reaction. Examples of bases include, but are not limited to, alkali metal hydroxides and alkoxides, such as sodium hydroxide. Acrylonitrile may then be added to the catalyst/functionalized polyfarnesene mixture dropwise. The Michael addition of acrylonitrile (cyanoethylation) to the monol or diol will form the corresponding cyanoalkylated compound.

In yet another example, the polyfarnesene may be provided with one or two epoxy end groups by, for example, a two-step process. In a first step, a polyfarnesene monol or diol and a monoepoxy compound may be combined in a solvent and allowed to react under pressure or in the presence of an inert gas, such as nitrogen or a noble gas. Examples of monoepoxy compounds include epihalohydrins, such as epichlorohydrin, beta-methylepichlorohydrin and epibromohydrin. The reactants may be optionally mixed with a catalyst, such as a metal salt or semimetal salt, the metal being selected from boron, aluminum, zinc and tin, and at least one anion selected from F⁻, Cl⁻, BF₄⁻, PF₆⁻, AsF₆⁻, SbF₆⁻, ClO₄⁻, IO₄⁻, and NO₃⁻. Following the first step, excess monoepoxy compound may be removed by distillation, for example, and then at least one alkali metal hydroxide may be added to the reaction mixture in order to form an alkali metal halide and the epoxy-terminated polyfarnesene.

According to yet another example, the polyfarnesene may be provided with one or two isocyanato end group. This may be accomplished by, for example, reacting a polyfarnesene having one or two amino end groups with phosgene.

As understood by one of skill in the art, the reactants used to provide the functionalized polyfarnesene may be dissolved in a suitable organic solvent and heat and/or pressure may be applied to the reaction to promote formation of the polyfarnesene. The reaction may be carried out batchwise or as a semicontinuous or continuous process. The reaction products may be recovered and treated by any conventional method, such as distillation, evaporation or fractionation to effect separation from unreacted material, solvent, if any, and by products.

According to the invention, said block copolymer is the reaction product of:
the at least one functionalized polyfarnesene described herein; and
at least one lactide;

Lactide is a cyclic dimer of lactic acid, glycolide, which is a cyclic dimer of glycolic acid, and caprolactone and the like. Lactide suitable herein includes L-lactide, which is a cyclic dimer of L-lactide, D-lactide, which is a cyclic dimer of D-lactide, meso-lactide, which is a cyclic dimer of D-lactide and L-lactide, and DL-lactide, which is a racemate of D-lactide and L-lactide. Random copolymers made from meso-lactide result in an atactic primary structure referred to as poly(meso-lactide) and are amorphous. Random optical copolymers made from equimolar amounts of D-lactide and L-lactide are referred to as poly-DL-lactide (PDLLA) or poly(rac-lactide) and are also amorphous.

The present block polymer can be prepared by contacting a lactide (such as L-lactide, D-lactide, LD-lactide, meso-lactide or a mixture thereof) with the herein functionalized polyfarnesene, thereby forming the block copolymer comprising at least one polyfarnesene block and at least one polylactide block.

The present invention therefore also encompasses the process for manufacturing the block copolymer according to the invention comprising the steps of:
contacting at least one functionalized polyfarnesene comprising a polymeric chain derived from farnesene and having at least one functional terminal end selected from the group comprising hydroxyl, amino, epoxy, isocyanato and carboxylic acid;
with at least one lactide; and polymerizing said lactide in the presence of said at least one functionalized polyfarnesene;
thereby forming said block copolymer comprising at least one polyfarnesene block and at least one polylactide block.

In an embodiment, the polymerization of the lactide in the presence of the at least one functionalized polyfarnesene occurs via ring opening polymerization.

In an embodiment, the polymerization of the lactide in the presence of the at least one functionalized polyfarnesene occurs in the presence of a catalyst.

In an embodiment, the polymerization of the lactide in the presence of the at least one functionalized polyfarnesene occurs in the presence of a catalyst having general formula M(Y¹, Y², . . . Y^{p})_{q}, wherein M is a metal selected from the group comprising the elements of columns 3 to 12 of the periodic table of the elements, as well as the elements Al, Ga, In, TI, Ge, Sn, Pb, Sb, Ca, Mg and Bi; whereas Y¹, Y², . . . Y^{p} are each substituents selected from the group comprising alkyl with 1 to 20 carbon atoms, aryl having from 6 to 30 carbon atoms, alkoxy having from 1 to 20 carbon atoms, aryloxy having from 6 to 30 carbon atoms, and other oxide, carboxylate, and halide groups as well as elements of group 15 and/or 16 of the periodic table; p and q are integers of from 1 to 6. As examples of suitable catalysts, we may notably mention the catalysts of Sn, Ti, Zr, Zn, and Bi; preferably an alkoxide or a carboxylate and more preferably Sn(Oct)₂, Ti(OiPr)₄, Ti(2-ethylhexanoate)₄, Ti(2-ethylhexyloxide)₄, Zr(OiPr)₄, Bi(neodecanoate)₃, (2,4-di-tert-butyl-6-(((2-(dimethylamino)ethyl)(methyl)amino)methyl)phenoxy)(ethoxy)zinc, or Zn(lactate)₂.

In an embodiment, the block copolymer can be produced by combining a lactide, respectively, with a functionalized polyfarnesene, preferably a hydroxy functionalized polyfarnesene. In some embodiments, the block copolymer can be produced by ring-opening polymerization of lactide using a hydroxy functionalized polyfarnesene as an initiator. Such processes may utilize catalysts, as described herein above, for polylactide formation, such as tin compounds (e.g., tin octylate), titanium compounds (e.g., tetraisopropyl titanate), zirconium compounds (e.g., zirconium isopropoxide), antimony compounds (e.g., antimony trioxide) or combinations thereof, for example.

The polymerization can be performed at a temperature of 150° C.−200° C. in bulk, or 90° C.−110° C. in solution. The temperature is preferably that of the reaction itself. According to an embodiment, without solvent, the polymerization can be performed at a temperature of 150° C.-200° C. in bulk.

The invention also relates to a polymer composition, comprising:
at least one polylactide; and,
at least one block copolymer according to an embodiment of the invention, or obtained according to an embodiment of the process for manufacturing a block copolymer of the invention. Hence, any embodiments of the block copolymers and embodiments of the process are embodiments of the polymer composition.

In some embodiments of the polymer composition, said polylactide is selected from the group comprising poly-L-lactide, poly-D-lactide, poly-DL-lactide, poly-meso-lactide, and mixture thereof.

As used herein, the terms “polylactic acid” or “polylactide” or “PLA” are used interchangeably and refer to poly(lactic acid) polymers comprising repeat units derived from lactic acid.

Polylactide can be prepared according to any method known in the state of the art. The polylactide can be prepared by ring-opening polymerization of raw materials having required structures selected from lactide, which is a cyclic dimer of lactic acid, glycolide, which is a cyclic dimer of glycolic acid, and caprolactone and the like. Lactide includes L-lactide, which is a cyclic dimer of L-lactic acid, D-lactide, which is a cyclic dimer of D-lactic acid, meso-lactide, which is a cyclic dimer of D-lactic acid and L-lactic acid, and DL-lactide, which is a racemate of D-lactide and L-lactide. Random copolymers made from meso-lactide result in an atactic primary structure referred to as poly(meso-lactic acid) and are amorphous. Random optical copolymers made from equimolar amounts of D-lactide and L-lactide are referred to as poly-DL-lactic acid (PDLLA) or poly(rac-lactic acid) and are also amorphous.

The PLLA (poly-L-lactide) suitable for the invention comprises the product of a polymerization reaction of mainly L-lactides (or L,L-lactides). Other suitable PLLA can be copolymers of PLLA with some D-lactic acid units. The term “poly-L-lactide (PLLA)” refers to the isotactic polymer with the general structure (II):

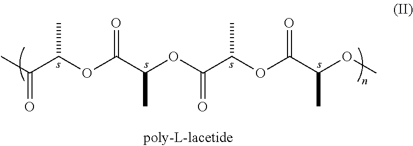

The PDLA (poly-D-lactide) for use in the present invention comprises the product of a polymerization reaction of mainly D-lactides. Other suitable PDLA can be copolymers of PDLA with some L-lactic acid units. The term “poly-D-lactide (PDLA)” refers to the enantiomer of PLLA.

The polylactide for use in the present composition also includes copolymers of lactic acid. For instance, copolymers of lactic acid and trimethylene carbonate according to EP 11167138 and copolymers of lactic acid and urethanes according to WO 2008/037772 and PCT application number PCT/EP2011/057988, hereby incorporated by reference. Copolymeric components other than lactic acid may be used and include dicarboxylic acid, polyhydric alcohol, hydroxycarboxylic acid, lactone, or the like, which have two or more functional groups each capable of forming an ester bonding. These are, for example, polyester, polyether, polycarbonate, or the like which have the two or more unreacted functional groups in a molecule. The hydroxycarboxylic acids may be selected from the list comprising glycolic acid, hydroxybutyric acid, hydroxyvaleric acid, hydroxypentanoic acid, hydroxycaproic acid, and hydroxyheptanoic acid. In an embodiment no comonomer is used.

In an embodiment, the PLLA and/or the PDLA which can be used in the composition respectively, can have an optical purity (called isomeric purity) of the L or D isomer, which is higher than 90% of the PLA, preferably higher than 92% of the PLA, preferably higher than 95 w % by weight. An optical purity from at least 98% by weight is more preferred, yet more preferably from at least 99%.

Optical purity can be measured by different techniques, such as NMR, polarimetry or by enzymatic method or GCMS. Preferably, optical purity is measured by enzymatic method and/or NMR, as described for herein below. Enzymatic method: The stereochemical purity of the PLLA or of the PDLA can be determined from the respective content of L-mer or of D-mer. The terms “content of D-mer” and “content of L-mer” refer respectively to the monomer units of type D and of type L that occur in polylactide, using the enzymatic method. The principle of the method is as follows: The L-lactate and D-lactate ions are oxidized to pyruvate respectively by the enzymes L-lactate dehydrogenase and D-lactate dehydrogenase using nicotinamide-adenine dinucleotide (NAD) as coenzyme. To force the reaction in the direction of formation of pyruvate, it is necessary to trap this compound by reaction with hydrazine. The increase in optical density at 340 nm is proportional to the amount of L-lactate or of D-lactate present in the sample. The samples of PLA can be prepared by mixing 25 ml of sodium hydroxide (1 mol/L) with 0.6 g of PLA. The solution was boiled for 8 h and then cooled. The solution was then adjusted to neutral pH by adding hydrochloric acid (1 mol/L), then deionized water was added in a sufficient amount to give 200 ml. The samples were then analyzed on a Vital Scientific Selectra Junior analyzer using, for L-mer determination of poly-L-lactide acid, the box titled “L-lactic acid 5260” marketed by the company Scil and for D-mer determination of poly-D-lactide acid, the box titled “L-lactic acid 5240” marketed by the company Scil. During the analysis, a reactive blank and calibration using the calibrant “Scil 5460” are used. The presence of insertion and racemization defects can also be determined by carbon-13 nuclear magnetic resonance (NMR) (Avance, 500 MHz, 10 mm SELX probe). The samples can be prepared from 250 mg of PLA dissolved in 2.5 to 3 ml of CDCl₃.

In an embodiment, PLLA suitable for the composition comprises a content of D isomer of at most 20% by weight, preferably of at most 10% by weight, preferably of at most 8% by weight, preferably of at most 5% by weight, more preferably of at most 2% by weight, most preferably of at most 1% by weight of the PLLA.

In an embodiment, PDLA suitable for the composition comprises a content of L isomer of at most 20% by weight, preferably of at most 10% by weight, preferably of at most 8% by weight, preferably of at most 5% by weight, preferably of at most 2% by weight of the PDLA more preferably of at most 1% by weight of the PDLA.

In an embodiment, a process for preparing polylactide suitable for the composition comprises the step of contacting at least one lactide, with a suitable catalyst, optionally in the presence of a co-initiator. The process may be performed with or without solvent.

The catalyst employed by the process may have general formula M(Y¹, Y², . . . Y^{p})_{q}, in which M is a metal selected from the group comprising the elements of columns 3 to 12 of the periodic table of the elements, as well as the elements Al, Ga, In, TI, Ge, Sn, Pb, Sb, Ca, Mg and Bi; whereas Y¹, Y², . . . Y^{p} are each substituents selected from the group comprising alkyl with 1 to 20 carbon atoms, aryl having from 6 to 30 carbon atoms, alkoxy having from 1 to 20 carbon atoms, aryloxy having from 6 to 30 carbon atoms, and other oxide, carboxylate, and halide groups as well as elements of group 15 and/or 16 of the periodic table; p and q are integers of from 1 to 6. As examples of suitable catalysts, we may notably mention the catalysts of Sn, Ti, Zr, Zn, and Bi; preferably an alkoxide or a carboxylate and more preferably Sn(Oct)₂, Ti(OiPr)₄, Ti(2-ethylhexanoate)₄, Ti(2-ethylhexyloxide)₄, Zr(OiPr)₄, Bi(neodecanoate)₃, (2,4-di-tert-butyl-6-(((2-(dimethylamino)ethyl)(methyl)amino)methyl)phenoxy)(ethoxy)zinc, or Zn(lactate)₂.

In an embodiment, the polylactide suitable for the composition can be obtained by polymerizing (such as L-lactide, D-lactide, LD-lactide, meso-lactide or a mixture thereof), preferably in the presence of a co-initiator of formula (III),

R¹—OH (III)

wherein R¹ is selected from the group consisting of C₁₋₂₀alkyl, C₆₋₃₀aryl, and C₆₋₃₀arylC₁₋₂₀alkyl optionally substituted by one or more substituents selected from the group consisting of halogen, hydroxyl, and C₁₋₆alkyl. Preferably, R¹ is selected from C₃₋₁₂alkyl, C₆₋₁₀aryl, and C₆₋₁₀arylC₃₋₁₂alkyl, optionally substituted by one or more substituents, each independently selected from the group consisting of halogen, hydroxyl, and C₁₋₆alkyl; preferably, R¹ is selected from C₃₋₁₂ alkyl, C₆₋₁₀aryl, and C₆₋₁₀ arylC₃₋₁₂ alkyl, optionally substituted by one or more substituents, each independently selected from the group consisting of halogen, hydroxyl and C₁₋₄alkyl. The initiator can be an alcohol. The alcohol can be a polyol such as diol, triol or higher functionality polyhydric alcohol. The alcohol may be derived from biomass such as for instance glycerol or propanediol or any other sugar-based alcohol such as for example erythritol. The alcohol can be used alone or in combination with another alcohol.

In an embodiment, non-limiting examples of initiators include 1-octanol, isopropanol, propanediol, trimethylolpropane, 2-butanol, 3-buten-2-ol, 1,3-butanediol, 1,4-butanediol, 1,6-hexanediol, 1,7-heptanediol, benzyl alcohol, 4-bromophenol, 1,4-benzenedimethanol, and (4-trifluoromethyl)benzyl alcohol; preferably, said initiator is selected from 1-octanol, isopropanol, and 1,4-butanediol.

The polymerization can be performed at a temperature of 60° C.−200° C. The temperature is preferably that of the reaction itself. According to an embodiment, without solvent, the polymerization can be performed at a temperature of 110° C.−200° C. in bulk. (Dear inventors, kindly let us know if this is according to the invention).

In some embodiments, the polymer composition, comprises at least 10.0% by weight of said at least one polylactide based on the total weight of the polymer composition, preferably at least 20.0% by weight, preferably at least 30.0% by weight, preferably at least 40.0% by weight, preferably at least 50.0% by weight, for example at least 60.0% by weight, for example at least 70.0% by weight, for example at least 75.0% by weight, for example at least 80.0% by weight, for example at least 85.0% by weight, for example at least 90.0% by weight, for example at least 95.0% by weight, based on the total weight of the polymer composition.

In some embodiments, the polymer composition, comprises at most 95.0% by weight of said at least one polylactide based on the total weight of the polymer composition, preferably at most 90.0% by weight, preferably at most 80.0% by weight, for example at most 75.0% by weight, for example at most 70.0% by weight, for example at most 60.0% by weight, for example at most 50.0% by weight based on the total weight of the polymer composition.

In some embodiments, said polymer composition further comprises at least one compatibilizer. Preferably, said compatibilizer is a co- or ter-polymer, and more preferably, the compatibilizer is a co- or ter-polymer comprising ethylene or styrene monomer, an unsaturated anhydride-, epoxide- or carboxylic acid-containing monomer and optionally a (meth)acrylic ester monomer. If present, the compatibilizer is preferably present in an amount ranging from 0.1 to 20% by weight, more preferably from 0.1 to 15% by weight, even more preferably from 0.5 to 10% by weight, most preferably from 1 to 5% by weight based on the total weight of the polymer composition.

Preferably, said compatibilizer is a co- or ter-polymer comprises: (a) 50 to 99.9% by weight of ethylene or styrene monomer, preferably 50 to 99.8% by weight, (b) 0.1 to 50% by weight of an unsaturated anhydride-, epoxide- or carboxylic acid-containing monomer, and (c) 0 to 50% by weight of a (meth)acrylic ester monomer, the total sum of components being 100% by weight.

In the embodiment, said compatibilizer is a co-polymer, said copolymer comprises preferably: (a) 50 to 99.9% by weight of ethylene or styrene monomer, preferably 50 to 99% by weight, and (b) 0.1 to 50% by weight of an unsaturated anhydride-, epoxide- or carboxylic acid-containing monomer, preferably 1 to 50% by weight, the total sum of components being 100% by weight.

In the embodiment, said compatibilizer is a ter-polymer, said ter-polymer comprises preferably: (a) 50 to 99.8% by weight of ethylene or styrene monomer, (b) 0.1 to 50% by weight of an unsaturated anhydride-, epoxide- or carboxylic acid-containing monomer, (c) 0.1 to 50% by weight of a (meth)acrylic ester monomer, the total sum of components being 100% by weight.

In some embodiments wherein the said compatibilizer is a co- or ter-polymer, the ethylene or styrene monomer (a) is present from 50 to 99.9% by weight, preferably from 50 to 99.8% by weight, more preferably from 60 to 99.5% by weight, even more preferably from 65 to 99% by weight, most preferably from 70 to 98% by weight. In the embodiment of the copolymer, the ethylene or styrene monomer can be present from 90 to 98% by weight.

In some embodiments wherein the said compatibilizer co- or ter-polymer, the unsaturated monomer (b) is preferably selected from an unsaturated anhydride- or epoxide-containing monomer. More preferably, the unsaturated monomer (b) is selected from a glycidyl (meth)acrylate or maleic anhydride. The unsaturated monomer (b) is preferably present from 0.1 to 40% by weight, more preferably from 0.2 to 30% by weight, even more preferably from 0.3 to 20% by weight, yet even more preferably from 0.3 to 15% by weight and most preferably from 0.3 to 10% by weight of the co- or ter-polymer.

The (meth)acrylic ester monomer (c), if present, is preferably selected from those acrylates which have between 1 and 10 carbon atoms such as for example methyl (meth)acrylate, ethyl (meth)acrylate, n-butyl (meth)acrylate, iso-butyl (meth)acrylate, 2-ethylhexyl (meth)acrylate, or n-octyl (meth)acrylate. If present, it preferably makes up 0.1 to 50% by weight of the terpolymer, preferably 0.5 to 40% by weight, more preferably 1 to 30% by weight, even more preferably 2 to 25% by weight and most preferably 5 to 25% by weight of the terpolymer.

The copolymers of ethylene or styrene monomer and of a glycidyl (meth)acrylate or maleic anhydride can contain from 50 to 99% by weight of ethylene or styrene monomer and from 1 to 50% by weight of a glycidyl (meth)acrylate or maleic anhydride, preferably from 90 to 98% by weight of ethylene or styrene monomer and from 2 to 10% by weight of a glycidyl (meth)acrylate or maleic anhydride, the total sum of components being 100% by weight.

The terpolymers of ethylene or styrene monomer, of a glycidyl (meth)acrylate or maleic anhydride and of a (meth)acrylic ester monomer can contain from 50 to 98.8% by weight of ethylene or styrene monomer, from 0.2 to 10% by weight of a glycidyl (meth)acrylate or maleic anhydride and from 1 to 50% by weight of a (meth)acrylic ester monomer, the total sum of components being 100% of the terpolymer. Preferably the terpolymer can contain from 55 b 97.7% by weight of ethylene or styrene monomer, from 0.3 to 8% of a glycidyl (meth)acrylate or maleic anhydride, and from 2 to 35% of (meth)acrylic ester monomer, the total sum of components being 100% of the terpolymer.

Still more preferably, when the compatibilizer is a co- or ter-polymer, the co- or ter-polymer is selected among copolymers of ethylene and glycidyl methacrylate and terpolymers of ethylene or styrene, acrylic ester monomers and glycidyl methacrylate or maleic anhydride. Non-limiting examples comprise glycidyl methacrylate grafted polypropylene (PP-g-GMA), epoxy-functionalized polyethylene such as polyethylene co-glycidyl methacrylate (PE-co-GMA), and combinations thereof. Non-limiting examples of suitable epoxy-functionalized polyethylene includes LOTADER® GMA products such as, for example, product LOTADER® AX8840, which is a random copolymer of ethylene and glycidyl methacrylate (PE-co-GMA) having 8% GMA content (as measured by FTIR), or product LOTADER® AX8900 which is a random terpolymer of ethylene, methyl acrylate and glycidyl methacrylate (having 8% GMA content, 68% by weight of ethylene monomer, and 24% by weight methyl acrylate), Lotader®4700 a terpolymer of ethylene, ethylacrylate and maleic anhydride; which are commercially available products from Arkema. Suitable co- or ter-polymer also include the terpolymer of styrene monomer, acrylic esters and glycidyl methacrylate sold under the trademark Joncryl® by BASF. Suitable example of such polymer is Joncryl® 4368 a styrenic-glycidyl acrylate polymer of the following formula.

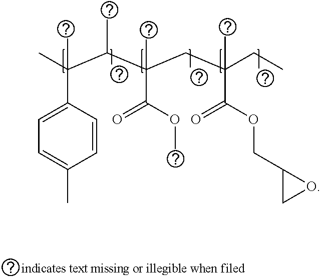

The compatibilizer can be blended either in dry form or in the melt with the rest of the polymer composition.

In a preferred embodiment, said compatibilizer is compounded in the compounded with the other ingredients according to any known compounding method in the art, e.g. mixer, like a Banbury mixer, or an extruder, preferably a twin screw extruder. The extrusion can be carried out at a temperature preferably below 230° C.

The invention also provides a process for preparing the polymer composition, comprising the step of contacting at least one polylactide with the at least one block polymer. Hence, every embodiment of the block copolymer and the polymer composition are also embodiments of this process.

Any process known in the art can be applied for preparing a polymer composition as presently described.

In some embodiments, said contacting step comprises melt blending the at least one polylactide with the at least one block copolymer.

In some embodiments, said contacting step comprises melt blending the at least one polylactide with the at least one block copolymer at a temperature ranging from 160° C. to 230° C., preferably at a temperature ranging from 160° C. to 200° C.

In some embodiments, said contacting step comprises melt blending the at least one polylactide with the at least one block copolymer. In some embodiments, said melt blending process occurs, in a single step. The blending may occur by introducing at least one polylactide and the at least one block copolymer, into a system capable of combining and melting the components to initiate chemical and/or physical interactions between the polylactide and the block copolymer components. For example, the blending may be accomplished by introducing the at least one polylactide and the at least one block copolymer into a batch mixer, continuous mixer, single screw extruder or twin screw extruder, for example, to form a homogeneous mixture or solution while providing temperature conditions so as to melt the blend components and initiate chemical and physical interactions of the at least one polylactide and the at least one block copolymer components as described above.

In an embodiment, the composition is prepared by mixing. In an embodiment, the composition is mixed at a temperature of at least 140° C., for example at least 150° C., for example at least 160° C., for example ranging from 160° C. to 230° C. More preferably, the composition is mixed at a temperature ranging from 180° C. to 230° C.

In a preferred embodiment, the residence time in the mixer is at most 30 minutes, more preferably at most 20 minutes, more preferably at most 10 minutes, more preferably at most 8 minutes, more preferably at most 5 minutes. As used herein, the term “residence time” refers to the time wherein the mixture is present in the mixer, or is present in a series of extruders.

In an embodiment, any of the previously described compositions may further comprise additives to impart desired physical properties, such as printability, increased gloss, or a reduced blocking tendency. Examples of additives may include, without limitation, stabilizers, ultra-violet screening agents, oxidants, anti-oxidants, antistatic agents, ultraviolet light absorbents, fire retardants, processing oils, mold release agents, coloring agents, pigments/dyes, fillers or combinations thereof, for example. These additives may be included in amounts effective to impart desired properties.

In some embodiments, said process for preparing a composition according to the present invention further comprises processing the polymer composition using one or more polymer processing techniques selected from the group comprising film, sheet, pipe and fiber extrusion or coextrusion; blow molding; injection molding; rotomolding; foaming; 3D printing, and thermoforming.

The present invention also encompasses an article comprising a block copolymer according to any of the embodiments previously described for the present invention, a polymer composition according to any of the embodiments previously described for the present invention, or prepared using a process according to the invention.

The present invention also encompasses polymers, membranes, adhesives, foams, sealants, molded articles, films, extruded articles, fibers, elastomers, composite material, adhesives, organic LEDs, organic semiconductors, and conducting organic polymers, 3D printed articles, comprising the polymer composition according to the present invention or the block copolymer according to the present invention.

In some embodiments, said article comprising a block copolymer according to any of the embodiments previously described for the present invention, a polymer composition according to any of the embodiments previously described for the present invention; is a shaped article.

In some embodiments, said shaped article comprising a block copolymer according to any of the embodiments previously described for the present invention, a polymer composition according to any of the embodiments previously described for the present invention; is a molded article.

In an embodiment, said shaped article is produced by polymer processing techniques known to one of skill in the art, such as blow molding, injection molding, rotomolding, compression molding, 3D printing, and thermoforming.

In an embodiment, the polymer compositions and blends thereof may be formed into a wide variety of articles such as films, pipes, fibers (e.g., dyeable fibers), rods, containers, bags, packaging materials, 3D printed articles, and adhesives (e.g., hot melt adhesives) for example, by polymer processing techniques known to one of skill in the art, such as forming operations including film, sheet, pipe and fiber extrusion and co-extrusion as well as blow molding, injection molding, rotomolding, 3D printing, and thermoforming, for example. Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, hot melt adhesives, sheets, such as thermoformed sheets (including profiles and plastic corrugated cardboard), geomembranes and pond liners, for example. Molded articles include single and multilayered constructions in the form of bottles, tanks, large hollow articles, rigid food containers and toys, for example.

The present invention is also directed towards the use of a polyfarnesene and polylactide block copolymer as a compatibilizer for polymers, preferably, said polymer is polylactide.

In some embodiments, the polyfarnesene and polylactide block copolymer is a block copolymer according an embodiment of the present invention.

The present invention is also directed towards the use of a polyfarnesene and polylactide block copolymer as an impact modifier for polymers, preferably, for polymers such as polylactide.

The present invention can be further illustrated by the following examples, although it will be understood that these examples are included merely for purposes of illustration and are not intended to limit the scope of the invention unless otherwise specifically indicated.

### Examples

Unless otherwise indicated, all parts and all percentages in the following examples, as well as throughout the specification, are parts by weight or percentages by weight respectively.

Materials:

Trans-β-farnesene was purchased from Amyris (CAS number 18794-84-8). The structure of trans-β-farnesene is given in formula (I)

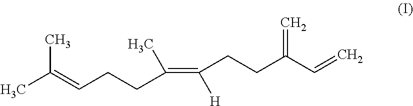

Solvents such as methanol, chloroform and toluene were purchased from Sigma-Aldrich, as anhydrous liquids.

n-Butyl lithium was purchased from Sigma Aldrich.

Propylene oxide was purchased from Sigma-Aldrich.

2-Tin-ethylhexanoate was purchased from VWR (Alfa Aesar supplier) with a purity of 96%.

JONCRYL®ADR-43680 (Joncryl) was purchased from BASF.

Lactide, Purified L-lactide from Total Corbion, named Puralact L was used.

Ingeo™ Biopolymer 2500HP (PLA HP2500) was purchased from NatureWorks.

The physical properties of Ingeo™ Biopolymer 2500HP are shown in Table 1.

TABLE 1

| Physical Properties | Ingeo Resin | ASTM Method |
|---|---|---|
| Specific Gravity | 1.24 | D792 |
| MFR, g/10 min (210° C., 2.16 kg) | 8 | D1238 |
| Relative viscosity(1) | 4.0 | D5225 |

(2) RV measured at 1.0 g/dL in chloroform at 30° C.

Methods

The molecular weight (Mₙ (number average molecular weight), M_{w} (weight average molecular weight), Mₚ (peak molecular weight) and molecular weight distributions D (M_{w}/Mₙ), and d′ (M_{z}/M_{w}) were determined by size exclusion chromatography (SEC) and in particular by gel permeation chromatography (GPC). Briefly, a GPC-IR5 from Polymer Char was used: 10 mg polymer sample was dissolved at 160° C. in 10 ml of trichlorobenzene for 1 hour. Injection volume: about 400 μl, automatic sample preparation and injection temperature: 160° C. Column temperature: 145° C. Detector temperature: 160° C. Two Shodex AT-806MS (Showa Denko) and one Styragel HT6E (Waters) columns were used with a flow rate of 1 ml/min. Detector: Infrared detector (2800-3000 cm-1). Calibration: narrow standards of polystyrene (PS) (commercially available). Calculation of molecular weight M, of each fraction i of eluted polyethylene is based on the Mark-Houwink relation (log₁₀(M_{PE})=0.965909×log 10(MPS)−0.28264) (cut off on the low molecular weight end at M_{PE}=1000).

The molecular weight averages used in establishing molecular weight/property relationships are the number average (Mₙ), weight average (M_{w}) and z average (M_{z}) molecular weight. These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} \text{/} {M}_{i}} = \frac{{\sum }_{i} {h}_{i}}{{\sum }_{i} {h}_{i} \text{/} {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {W}_{i}} = \frac{{\sum }_{i} {h}_{i} {M}_{i}}{{\sum }_{i} {h}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mᵢ. The third representation in each case (farthest right) defines how one obtains these averages from SEC chromatograms. hi is the height (from baseline) of the SEC curve at the iₜₕ elution fraction and Mᵢ is the molecular weight of species eluting at this increment.

Thermal properties were analyzed with Perkin-Elmer Pyris Diamond differential scanning calorimeter (DSC) calibrated with indium as standard. The specimens were heated from 20 to 220° C. at a rate of 20° C./min, under N₂, followed by an isothermal at 220° C. for 3 min, and a subsequent cooling scan to 20° C. at a rate of 20° C./min.

Mechanical properties of the compositions and block copolymers were investigated by Izod impact tester. Un-notched Izod impact was measured at 23° C. according to ISO180/A:2000. Unnotched test specimen 9.99 mm×4.21 mm (section 42.1 mm²) is held as a vertical cantilevered beam and is impacted at 3.5 m/s by a swinging pendulum (5.5 J).

Tensile modulus, tensile strength at yield, elongation at yield, tensile strength at break, elongation at break were determined according to ISO527-2012-1BA.

Haze was measured according to ISO 14782:1999 on injection molded plaques having a thickness of 1 mm.

Preparation of Polyfarnesene Mono-ol

100 g of trans-β-farnesene and 200 g of methyl-tert-butyl ether (MTBE) were combined in a pressure reactor and purged three times with nitrogen. Subsequently 1.3 g of n-butyl lithium was added to the reactor at room temperature. The reaction was monitored and the temperature controlled to stay below 40° C. After polymerization was completed (approximately 15 minutes), a stoichiometric excess of propylene oxide (2.0 g) was added to the living polymerization solution, followed by adding methanol (1.3 g) for neutralization. The polymer solution was then transferred to a three-neck flask equipped with a stirrer, and mixed well for 10 minutes with purified water to wash the polymer solution. The stirring was stopped and overtime the organic phase separated from the aqueous phase, at which point the aqueous phase was discharged and the pH determined. The washing step was repeated until the aqueous phase became neutral (pH 7). The separated organic phase was transferred to another three-neck flask and the MTBE solvent was removed under nitrogen purge with heating (150° C.). When the majority of solvent was removed, the polymer was steam stripped until one-half of the steam based on polymer volume was eliminated, then the polymer was nitrogen purged at 150° C. to pull out residual water. The isolated polyfarnesene having a hydroxyl end group was cooled to 70° C. and transferred to a container. The number average molecular weight of the polyfarnesene mono-ol was approximately 5000 g/mol.

Polyfarnesene mono-ol having Mn of about 20000 and 50000 Da were obtained similarly.

Preparation of Polyfarnesene Diol:

A polyfarnesene diol was prepared by combining 26.8 g (11.0 g for 50000 g/mol diol; 4.5 g for 110000 g/mol diol) of a di-lithium based initiator (prepared as described in example 2 of DD-231361 A1) and 1600 g of methyl-tert-butyl ether (MTBE) in a pressure reactor and purged with nitrogen three times. Subsequently, 225 g of trans-β-farnesene was added to the reactor at room temperature; the reaction was monitored and the temperature controlled to stay below 40° C. After polymerization was completed (approximately 15 minutes), a stoichiometric excess of propylene oxide (2.0 g) was added to the living polymerization solution, followed by adding purified water for neutralization. The polymer solution was mixed well for 15 minutes with purified water to wash the polymer solution. The stirring was stopped and over time the organic phase separated from the aqueous phase, at which point the aqueous phase was discharged and the pH determined. The washing step was repeated until the aqueous phase became neutral (pH=7). The separated organic phase was transferred to three-neck flask and the MTBE solvent was removed under nitrogen purge with heating (150° C.). When the majority of solvent was removed, the polymer was steam stripped until one-half of the steam based on polymer volume was eliminated, then the polymer was nitrogen purged at 150° C. to pull out residual water. The isolated polyfarnesene having a hydroxyl end group was cooled to 70° C. and transferred to a container. The number average molecular weight of the polyfarnesene was approximately 20000 (50000; 110000) g/mol.

### Preparation of poly-L-lactide-polyfarnesene(PLA-PF) Diblock Copolymer

PLA-PF diblock copolymers were prepared by reacting polyfarnesene mono-ols as prepared above with lactide in bulk, in the presence of a catalyst.

In this specific example the polyfarnesene mono-ol with a molecular weight of 20 000 g/mol was used. 2.81 mg tin(II) 2-ethylhexanoate (Sn(Oct)₂) (6.94 μmol, 1 equivalent) was added to 1.11 g polyfarnesene mono-ol (55.56 μmol, 8 equivalents) with a molecular weight of 20 000 g/mol, placed in 1 ml of dry toluene in a glass flask, under nitrogen atmosphere in a glove box. The obtained mixture was stirred for 1 hour at 50° C. in order to homogenize the mixture and to activate the catalyst. Subsequently 10 g of pure L-lactide (0.0694 mol, 10000 equivalents) was added to the flask. The reaction mixture was stirred for 90 minutes at 185° C., to achieve a conversion higher than 90%. The crude copolymer was dissolved in CHCl₃ and purified by precipitation in ethanol. The precipitate is filtered off and dried in a vacuum oven for 1 hour at 110° C. The resulting PLA-PF diblock copolymer is further referred to as 69/20. The number average molecular weight of the PLA-block in said copolymer is 69 000 g/mol and the number average molecular weight of the polyfarnesene-block is 20 000 g/mol.

Similarly, but with 2.22 g, 3.33 g and 4.44 g of polyfarnesene mono-ol, respectively diblock copolymers 26/20, 21/20 and 14/20 were prepared.

Diblock copolymers with a polyfarnesene block of 50 000 and 110 000 g/mol were prepared in a similar way.

### Preparation of poly-L-lactide-polyfarnesene-poly-L-lactide (PLA-PF-PLA) Triblock Copolymer

PLA-PF-PLA triblock copolymers were prepared by reacting polyfarnesene diol as prepared above with lactide in bulk, in the presence of a catalyst.

In this specific example the polyfarnesene diol with a molecular weight of 20 000 g/mol was used. 5.6 mg tin(II) 2-ethylhexanoate (Sn(Oct)₂) (13.89 μmol, 1 equivalent) was added to 2.5 g polyfarnesene diol (0.125 mmol, 9 equivalents) with a molecular weight of 20 000 g/mol, placed in 1 ml of dry toluene in a glass flask, under nitrogen atmosphere in a glove box. The obtained mixture was stirred for 1 hour at 50° C. in order to homogenize the mixture and to activate the catalyst. Subsequently 10 g of pure L-lactide (0.0694 mol, 5000 equivalents) was added to the flask. The reaction mixture was stirred for 90 minutes at 185° C., to achieve a conversion higher than 90%. The crude copolymer was dissolved in CHCl₃ and purified by precipitation in ethanol. The precipitate is filtered off and dried in a vacuum oven for 1 hour at 110° C. The resulting PLA-PF-PLA triblock copolymer is further referred to as 34/20/34. The number average molecular weight of each PLA-block in said copolymer is 34 000 g/mol and the number average molecular weight of the polyfarnesene-block is 20 000 g/mol.

Similarly, but with 3.75 g, 5.00 g and 6.25 g of polyfarnesene diol, respectively triblock copolymers 19/20/19, 14/20/14 and 12/20/12 were prepared.

Triblock copolymers with a polyfarnesene block of 2 000, 5 000, 50 000 and 110 000 g/mol were prepared in a similar way. For example, triblock copolymer 3/20/3 was similarly prepared with 5.05 g of lactide and 15 g of polyfarnesene diol. Triblock copolymer 166/50/166 was similarly prepared with 15.1 g of lactide and 1.8 g of polyfarnesene diol. Triblock copolymer 92/50/92 was similarly prepared with 15.1 g of lactide and 3.9 g of polyfarnesene diol. Triblock copolymer 51/50/51 was similarly prepared with 15.1 g of lactide and 6.7 g of polyfarnesene diol. Triblock copolymer 37/50/37 was similarly prepared with 15.1 g of lactide and 10.2 g of polyfarnesene diol. Triblock copolymer 24/50/24 was similarly prepared with 10.1 g of lactide and 10.1 g of polyfarnesene diol. Other block copolymers as listed in Table 2 were prepared in a similar way.

Table 2 shows a list of the prepared block copolymers and their characteristics. Column 1 of Table 2 names the different copolymers, the nomenclature referring to their composition. The first digit refer to the number average molecular weight in kDa of the PLA block separated by a back slash from the second digits, referring to the number average molecular weight in kDa of the PF block. The optional third digits refer the number average molecular weight in kDa of the optional second PLA block. Column 2 shows the number of polymer blocks in the copolymer. Column 3 shows the weight percent of solid material that is recovered after polymerization and work-up, expressed compared to the weight of the initial starting materials, being the weight of the lactide and the weight of the polyfarnesene. Column 4 shows the weight percent of the recovered solids after polymerization and work-up that is pure PLA, meaning PLA that is not a copolymer with polyfarnesene, and this expressed compared to the weight of the initial starting materials, being the weight of the lactide and the weight of the polyfarnesene. Column 5 shows the percentage by weight of the recovered solids after polymerization and work-up that is copolymer, and this is expressed compared to the weight of the initial starting materials, being the weight of the lactide and the weight of the polyfarnesene. Columns 6-8 show the number average molecular weights of each of the blocks of the block copolymer. Column 9 shows the experimentally determined weight percentage of the copolymer that is polyfarnesene, this is determined from the ratio of Mn polyfarnesene (starting material) over Mn copolymer. Column 10 shows the number average molecular weight of the copolymer. Column 11 shows the weight average molecular weight of the copolymer. Column 12 shows the peak molecular weight of the copolymer and column 13 shows the molecular weight distribution D (Mw/Mn) of the copolymer, determined as described above.

TABLE 2

| | | | | | Bloc 1 | Bloc 2 | Bloc 3 | % PF exp. | GPC Mn | GPC Mw | GPC Mp | |
|---|---|---|---|---|---|---|---|---|---|---|---|---|
| | number | % | % PLA | % | PLA (Mn) | PF (Mn) | PLA (Mn) | (Mn ratio) | Copo | Copo | Copo | |
| Ref. | of blocks | Precipitation | pure | copo | Da | Da | Da | % w/w | Da | Da | Da | GPCD |
| L-F | | | | | PLA-- | --PF | | | | | | |
| 69/20 | 2 | 92 | 47 | 45 | 69 000 | 20 000 | 0 | 22 | 89 000 | 194 000 | 120 000 | 2.1 |
| 26/20 | 2 | 93 | 46 | 47 | 26 000 | 20 000 | 0 | 43 | 46 000 | 89 000 | 51 000 | 1.9 |
| 21/20 | 2 | 93 | 32 | 61 | 21 000 | 20 000 | 0 | 49 | 41 000 | 77 000 | 34 000 | 1.9 |
| 14/20 | 2 | 91 | 23 | 68 | 14 000 | 20 000 | 0 | 59 | 34 000 | 59 000 | 27 000 | 1.7 |
| 110/50 | 2 | 92 | 59 | 33 | 110 000 | 50 000 | 0 | 30 | 160 000 | 325 000 | 340 000 | 2.0 |
| 52/50 | 2 | 93 | 52 | 41 | 52 000 | 50 000 | 0 | 49 | 102 000 | 185 000 | 149 000 | 1.81 |
| 39/50 | 2 | 93 | 38 | 55 | 39 000 | 50 000 | 0 | 55 | 89 000 | 138 000 | 96 000 | 1.55 |
| 19/50 | 2 | 90 | 34 | 56 | 19 000 | 50 000 | 0 | 72 | 69 000 | 108 000 | 76 000 | 1.5 |
| L-F-L | | | | | PLA-- | --PF-- | --PLA | | | | | |
| 3/2/3 | 3 | 86 | — | — | 2 900 | 2 000 | 2 900 | 26 | 7 800 | 10 920 | 7 390 | 1.4 |
| 1/2/1 | 3 | 81 | — | — | 900 | 2 000 | 900 | 53 | 3 800 | 4 560 | 4 100 | 1.2 |
| 02/2/02 | 3 | 80 | — | — | 200 | 2 000 | 200 | 83 | 2 400 | 2 880 | 2 700 | 1.2 |
| 8/5/8 | 3 | 94 | — | — | 8 200 | 5 000 | 8 200 | 23 | 21 400 | 36 000 | 32 000 | 1.7 |
| 3/5/3 | 3 | 90 | — | — | 3 050 | 5 000 | 3 050 | 45 | 11 100 | 12 000 | 11 000 | 1.3 |
| 1/5/1 | 3 | 86 | — | — | 1 050 | 5 000 | 1 050 | 70 | 7 100 | 8 500 | 8 600 | 1.14 |
| 34/20/34 | 3 | 94 | 7 | 87 | 33 500 | 20 000 | 33 500 | 23 | 87 000 | 172 000 | 146 000 | 1.9 |
| 25/20/25 | 3 | 96 | 10 | 86 | 25 000 | 20 000 | 25 000 | 29 | 70 000 | 134 000 | 115 000 | 1.9 |
| 19/20/19 | 3 | 93 | 7 | 86 | 18 500 | 20 000 | 18 500 | 35 | 57 000 | 121 000 | 105 000 | 2.1 |
| 14/20/14 | 3 | 96 | 3 | 93 | 13 500 | 20 000 | 13 500 | 43 | 47 000 | 89 000 | 75 000 | 1.8 |
| 12/20/12 | 3 | 95 | — | — | 11 500 | 20 000 | 11 500 | 47 | 43 000 | 59 000 | 56 000 | 1.4 |
| 3/20/3 | 3 | 95 | 1 | 94 | 2 500 | 20 000 | 2 500 | 80 | 25 000 | 30 000 | 29 000 | 1.2 |
| 166/50/166 | 3 | 93 | 6 | 87 | 165 500 | 50 000 | 165 500 | 13 | 381 000 | 685 000 | 610 000 | 2.3 |
| 92/50/92 | 3 | 94 | — | 95 | 91 500 | 50 000 | 91 500 | 21 | 233 000 | 443 000 | 450 000 | 1.9 |
| 51/50/51 | 3 | 93 | 2 | 91 | 51 000 | 50 000 | 51 000 | 33 | 152 000 | 258 000 | 261 000 | 1.7 |
| 37/50/37 | 3 | 96 | — | — | 37 000 | 50 000 | 37 000 | 40 | 124 000 | 224 000 | 230 000 | 1.8 |
| 24/50/24 | 3 | 94 | — | — | 24 000 | 50 000 | 24 000 | 51 | 98 000 | 157 000 | 131 000 | 1.6 |
| 240/206/240 | 3 | | | | 240 000 | 206 000 | 240 000 | | | | | |

Properties of the Block Copolymers

Samples were injection molded using the block copolymers (Table 3) for further testing. The block copolymer was heated from 140° C. to 210° C., the heating time was 3 minutes, and the injection time was 2 seconds and this without support pressure.

Table 3 shows an overview of the properties of the PLA-PF block copolymers according to the invention, no purification has been carried out to separate the pure PLA side product from the PLA-PF copolymer.

Column 1 of Table 3 names the different copolymers, entry 1 (PLA) shows the results for the reference material of pure PLA polymer, said reference PLA material is commercial available from NatureWorks under the name Ingeo™ Biopolymer 2500HP. Column 2 shows the glass transition temperature of the PLA component of the copolymers, determined by DSC according to ISO 11357 with a gradient going from 20 to 220° C. at 20° C./min. Column 3 shows the melting temperature of the copolymers, determined by DSC according to ISO 11357 with a gradient going from 20 to 220° C. at 20° C./min. Column 4 shows the crystallization temperature of the copolymers, determined according to ISO 11357 with a gradient going from 20 to 220° C. at 20° C./min. Column 5 shows the tensile modulus of the copolymers. Column 6 shows the tensile strength at yield of the copolymers. Column 7 shows the elongation at yield of the copolymers. Column 8 shows the tensile strength at break of the copolymers. Column 9 shows the elongation at break of the copolymers.

TABLE 3

| | | | | | Tensile | | Tensile | |
|---|---|---|---|---|---|---|---|---|
| | | | | Tensile | strength at | Elongation | strength | Elongation |
| | Tg(PLA) | Tm | Tc | modulus | yield | at yield | at break | at break |
| Ref. | ° C. | ° C. | ° C. | Mpa | Mpa | % | Mpa | % |
| PLA | ~65 | ~176 | ~115 | 2732 | dumbbell broken | dumbbell broken | 66 | 4 |
| | | | | | before yield | before yield | | |
| L-F | | | | | | | | |
| 69/20 | 61 | 175 | 107 | 1903 | 37 | 2.3 | 18 | 13 |
| 26/20 | 61 | 173 | 123 | 26 | 0.7 | 1.5 | 0.6 | 2.7 |
| 21/20 | 58 | 175 | 114 | | | | | |
| 14/20 | 58 | 173 | 110 | | | | | |
| 110/50 | 62 | 175 | 114 | 2189 | 44 | 2.4 | 27 | 4.9 |
| 52/50 | 62 | 175 | 113 | 982 | 11 | 1.1 | 10 | 1.2 |
| 39/50 | 62 | 175 | 117 | | | | | |
| L-F-L | | | | | | | | |
| 3/2/3 | — | 155 | 91 | | | | | |
| 1/2/1 | 52 | 134 | 83 | | | | | |
| 8/5/8 | 59 | 165 | 138 | | | | | |
| 3/5/3 | — | 153 | 120 | | | | | |
| 34/20/34 | | | | 1264 | 12.3 | 1 | 6.5 | 10 |
| 25/20/25 | 50 | 169 | | | | | | |
| 19/20/19 | | | | 372 | 6.3 | 3 | 5.1 | 63 |
| 14/20/14 | | | | 6 | 0.7 | 7 | 0.7 | 7 |
| 3/20/3 | — | 173 | 98 | | | | | |
| 166/50/166 | 63 | 174 | 126 | 2419 | 56 | 2.9 | 30 | 4 |
| 92/50/92 | 64 | 175 | 111 | 1582 | 27 | 2 | 15 | 3 |
| 51/50/51 | 55 | 171 | — | 53 | 0.8 | 1 | 0.8 | 1 |
| 37/50/37 | 62 | 174 | — | 52 | 1.7 | 2.4 | 1.5 | 3 |
| 24/50/24 | 63 | 174 | — | 23 | 0.8 | 4 | 0.9 | 6 |

Compositions Comprising the Block Copolymers and PLA

Different compositions comprising PLA and the block copolymers were prepared. The composition comprised 70% by weight of PLA HP2500 and 30% by weight of different block copolymers shown in Table 2 and 3.

The compositions were melt blended in a Brabender internal mixer, at 200° C., 50 rpm, for a residence time of 3 to 4 minutes.

Samples were injection molded for further testing. The blends were heated from 140° C. to 220° C., the mold was at ambient temperature (23° C.), the heating time was 3 minutes, and the injection time was 2 seconds and this without support pressure.

Table 4 shows the mechanical properties of different compositions according to the invention. Column 1 names the compositions by referring to the type of PLA-PF copolymer that is being used to make the blend. Column 2 shows the tensile modulus of the blend. Column 3 shows the tensile strength at break of the blend. Column 4 shows the elongation at break of the blend. Column 5 shows the Izod impact of the blend. Column 6 shows the haze of the blend. Column 7 shows the number average molecular weight of the blend. Column 8 shows the weight average molecular weight of the blend. Column 9 shows the z average molecular weight of the blend. Column 10 shows the molecular weight distributions D (M_{w}/Mₙ) of the blend.

TABLE 4

| | Tensile | Tensile | Elongation | Izod impact | | Mn | Mw | Mz | |
|---|---|---|---|---|---|---|---|---|---|
| | modulus | strength at | at break | ( | Haze | blend | blend | blend | D |
| Ref | Mpa | Mpa | % | kJ/m² | % | kDa | kDa | kDa | blend |
| PLA | 2732 | 66 | 4 | 17.3 | | 109 | 225 | 361 | 2.1 |
| 69/20 | 2430 | 45.5 | 4.4 | 16.6 | | 76 | 177 | 314 | 2.3 |
| 26/20 | 2144 | 40.8 | 3.0 | 14.9 | 55.2 | 57 | 119 | 231 | 2.1 |
| 14/20 + 21/20 + 0.5% Joncryl | 278 | 2.8 | 1.1 | 4.5 | | | | | |
| 110/50 | 2579 | 52.9 | 3.8 | 16.2 | 62.7 | 82 | 201 | 372 | 2.4 |
| 52/50 | 2371 | 29.6 | 6.6 | 17.1 | 76.1 | 79 | 171 | 299 | 2.2 |
| 39/50 | 1617 | | | 21.0 | | | | | |
| 34/20/34 | 2386 | 39.9 | 4.2 | 18.4 | 25.6 | 86 | 190 | 324 | 2.2 |
| 25/20/25 | 2241 | 20.0 | 120 | 15.0 | | | | | |
| 25/20/25 + 1% Joncryl | 2600 | 36.7 | 130 | 20.2 | | | | | |
| 19/20/19 | 2333 | 45.7 | 8 | 16.0 | 26.7 | 74 | 158 | 279 | 2.1 |
| 14/20/14 + 0.5% Joncryl | 1416 | 11 | 34 | 15.8 | | | | | |
| 12/20/12 + 0.5% Joncryl | 595 | 8 | 4 | 11.5 | | | | | |
| 3/20/3 + 0.5% Joncryl | 273 | 3 | 1 | 5.1 | | | | | |
| 165/50/165 | 2547 | 48.0 | 4.0 | 17.9 | 29.0 | 107 | 274 | 558 | 2.6 |
| 92/50/92 | 2140 | 36.0 | 4.9 | 16.3 | 30.2 | 110 | 277 | 553 | 2.5 |
| 51/50/51 | 2227 | 18.0 | 54.0 | 13.7 | 30.7 | 111 | 243 | 439 | 2.2 |
| 37/50/37 | 1967 | 17.6 | 15.9 | 20.6 | 61.0 | 116 | 221 | 367 | 2.0 |
| 24/50/24 | 1169 | 7.0 | 17.1 | 28.2 | | 110 | 211 | 354 | 1.9 |
| 24/50/24 + 0.5% Joncryl | 2150 | 12.0 | 22 | 23 | | | | | |

1.-15. (canceled)

16. A block copolymer comprising a reaction product of:
at least one functionalized polyfarnesene comprising a polymeric chain derived from farnesene and having at least one functional terminal end selected from the group comprising hydroxyl, amino, epoxy, isocyanato, and a carboxylic acid; and
at least one lactide;
wherein the block copolymer comprises at least one polyfarnesene block and at least one polylactide block.

17. The block copolymer of 16, wherein the block copolymer is a di-block or a triblock copolymer.

18. The block copolymer of 16, wherein the number average molecular weight Mn of the at least one polyfarnesene block is from 1 to 300 kDa.

19. The block copolymer of 16, wherein the number average molecular weight Mn of the at least one polylactide block is from 0.2 to 400 kDa.

20. The block copolymer of 16, wherein the block copolymer is selected from the group comprising PLA-PF diblock copolymer, PLA-PF-PLA triblock copolymer, PLA-PF multiblock copolymer, PLA-PF star copolymers, PLA-PF gradient containing block copolymers; and mixtures thereof; preferably the block copolymer is a PLA-PF diblock copolymer or a PLA-PF-PLA triblock copolymer.

21. The block copolymer of 16, wherein the at least one polylactide (PLA) block is selected from the group comprising poly-L-lactide, poly-D-lactide, poly-DL-lactide, poly-meso-lactide, and mixtures thereof.

22. A process for manufacturing a block copolymer comprising:
contacting at least one functionalized polyfarnesene comprising a polymeric chain derived from farnesene and having at least one functional terminal end selected from the group comprising hydroxyl, amino, epoxy, isocyanato, and carboxylic acid;
with at least one lactide; and polymerizing the lactide in the presence of the at least one functionalized polyfarnesene;
thereby forming the block copolymer comprising at least one polyfarnesene block and at least one polylactide block.

23. A polymer composition, comprising:
at least one polylactide; and,
at least one block copolymer comprising a reaction product of:
at least one functionalized polyfarnesene comprising a polymeric chain derived from farnesene and having at least one functional terminal end selected from the group comprising hydroxyl, amino, epoxy, isocyanato, and a carboxylic acid; and
at least one lactide;
wherein the block copolymer comprise at least one polyfarnesene block and at least one polylactide block.

24. A polymer composition according to claim 23, wherein the at least one block copolymer is present in the polymer composition in an amount of at least 1.0% by weight.

25. A process for preparing a polymer composition, comprising contacting at least one polylactide with the at least one block polymer of claim 1.

26. The process according to claim 25, wherein the contacting step comprises melt blending the at least one polylactide with the at least one block copolymer.

27. An article comprising a block copolymer according to claim 16 or a polymer composition according to claim 23.

28. The use of the block copolymer of claim 16 as a compatibilizer for a polymer, wherein the polymer is a polylactide.

29. The use of the block copolymer of claim 16 as an impact modifier for a polymer, wherein the polymer is a polylactide.
